(19) United States
(12) Patent Application Publication
(10) Pub. No.: US 2008/0252258 A1
(43) Pub. Date: Oct. 16, 2008

(54) Charging Method for a Lead-acid Battery

(76) Inventors: Tzu-Fen CHANG, Taichung (TW); Tai-Hung Lin, Taichung (TW)

Correspondence Address: Dr. BANGER SHIA, 102 Lindencrest Ct., Sugar Land, TX, 77479-5201, US

(21) Appl. No.: 11/735,064

(22) Filed: Apr. 13, 2007

(51) Int. Cl. H02J 7/00

(52) U.S. Cl. 320/133

(57) ABSTRACT

A charging method for a lead-acid battery allows the lead-acid battery to finish charging within an hour, and keeps the temperature of the lead-acid battery below 40 C. The charging method comprises three important parts, which are charging period, rest period, and discharging period. The three parts cooperate together to achieve an objective that allows the lead-acid battery to finish charging within an hour, and keeps the temperature of the lead-acid battery below 40° C., otherwise the service life of the lead-acid battery will be shortened, and the lead-acid battery will even be destroyed.

### BACKGROUND OF THE INVENTION

1. Field of the Invention

The present invention relates to a charging method for a battery, and more particularly to a charging method for a lead-acid battery that allows the lead-acid battery to finish charging within an hour, and keeps the temperature of the lead-acid battery below 40° C.

2. Description of the Prior Art

At present, lead-acid batteries are widely used in various fields, such as engines, automobiles, emergency lighting, uninterruptible power supply systems and so on. And, an improper charging method usually reduces the charging efficiency of the battery, which will further increase the charging time and even cause high temperature of the battery, and high temperature will reduce the service life of the battery or even destroy the battery. Therefore, it is important to improve a charging method that can increase the service life of the lead-acid battery (battery for short hereinafter).

An ordinary charging method is showed in FIG. 4. The axis T represents time, and the axis Q represents current. The charging method provides a charging, discharging and rest period C that includes a charging part A, a discharging part D and a rest part B.

The charging method of the period comprises the following steps:

providing the battery with a charging part A, and the charging part serves to keep providing a charging pulse E to the battery for a period of time; entering the discharging part D after the charging part A, and the discharging part D serves to keep providing a discharging pulse F to the battery for a period of time; entering the rest part B after the discharging part D, and the rest part B serves to keep the input current of the battery as zero for a period of time.

The charging, discharging and rest period C is circularly repeated until the battery finishes charging. The conventional charging method will produce the following problems for the incomplete cooperation of each part:

A. The number of times of discharge is too great, which will reduce the charging efficiency.

B. Because the charging efficiency is reduced, the charging time will be increased, so that the battery cannot finish charging (within an hour) quickly, and will cause high temperature of the battery, which will reduce the service life of the battery or destroy the battery.

The present invention has arisen to mitigate and/or obviate the afore-described disadvantages.

### SUMMARY OF THE INVENTION

The primary objective of the present invention is to provide a charging method for a lead-acid battery that allows the lead-acid battery to finish charging within an hour, and keeps the temperature of the lead-acid battery below 40° C.

The secondary objective is to provide a charging method for the lead-acid battery that includes three parts, which are charging period, rest period, and discharging period. The three parts completely cooperate together, so that the charging method will not reduce the charging efficiency (charging efficiency is the rising rapidity of voltage of the battery. For example, a user can test the voltage every four minutes. If the charging efficiency is low, the voltage will increase only 0.01V every four minutes, and if the charging efficiency is good, the voltage will increase 0.1V every four minutes. When the battery finishes charging, the voltage is 14.0V, so if the voltage increases quickly, the battery can finish charging in a short time, therefore achieving the objective of charging quickly.), so that it will not cause high temperature and long charging time of the battery, which will reduce the service life of battery and even destroy the battery.

In order to achieve the abovementioned objective, the charging method of the present invention includes three important parts, which are charging period, rest period, and discharging period. The following is an illustration of the signification and function of each of the three parts.

A. The charging period serves to keep providing a charging pulse to the battery for a period of charging time. The charging pulse adopts a rated current charging method because the total charging time of the rated current charging method is shorter than a rated voltage charging method.

B. The rest period serves to keep the input current of the battery as zero, and allows ions of electrolyte in the inner part of the battery to distribute evenly, so as to improve the charging efficiency, therefore achieving the objective of charging quickly. During the course of charging, the inner part of the battery will produce air bubble that will adhere to the surface of electrode panels (There are two electrode panels in the inner part of a battery, that is positive electrode panel and a negative electrode panel.), so that ions produced on one electrode panel have to move to the other electrode panel (The charging and discharging activity depends on the two panels of the battery delivering ions.). The air bubble will prevent ions from moving to the other electrode panel, causing low charging efficiency and high temperature, and causing erosion of the electrode panels, therefore reducing the service life of the battery. The bubble produced during the course of charging cannot be solved in the rest period, so that a discharging pulse is needed to solve the problem.

C. The discharging period provides a discharging pulse to the battery that can prevent air bubble from being produced on the electrode panels, which can slow down the rising rapidity of temperature of the battery, and in the meantime, allows a higher charging current and improve charging efficiency. However, great number of times of discharge will reduce the charging efficiency.

The charging method of the present invention combines the three parts together, and solves some disadvantages (low charging efficiency, high temperature of the battery, total long charging time). By experimental testing, the battery finishes charging within an hour, and the temperature of the battery is kept not exceeding 40° C. through the following steps:

(A). providing the battery with a charging and rest section, and the charging and rest section includes two group cycles of charging and rest, and each cycle of charging and rest includes a charging period and a rest period, the charging period serves to provide a charging pulse to the battery, and the rest period serves to keep the input current of the battery as zero;

(B). providing the battery with a discharging section, and the discharging section serves to provide a discharging pulse to the battery;

(C). repeating the steps (A) and (B) alternately until the battery reaches to a rated voltage.

### BRIEF DESCRIPTION OF THE DRAWINGS

FIG. 1 is a perspective view of the best area coverage for charging;

FIG. 2 is a diagram of showing testing results of the number of times of charging of the charging method of the present invention;

FIG. 3 is a perspective view of the charging method in accordance with an embodiment of the present invention; and

FIG. 4 is a perspective view of a conventional charging method.

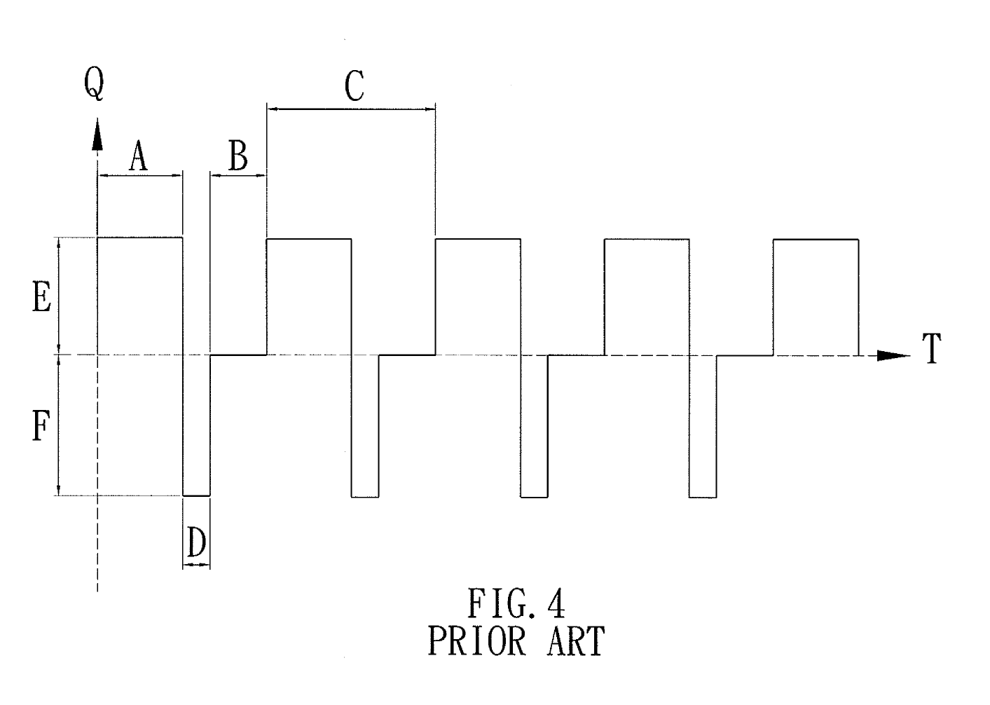

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

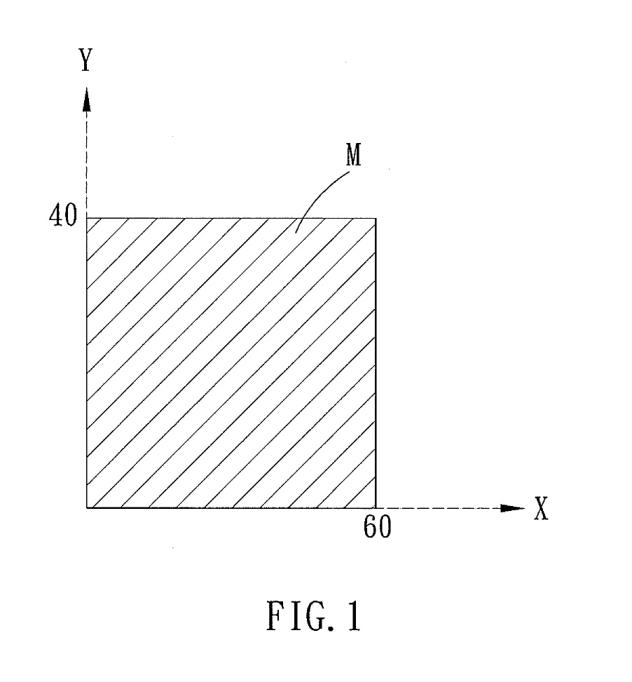

Referring to FIG. 1, it shows the optimum charging area M. The axis X represents time, and the unit is minute. The axis Y represents temperature, and the unit is ° C. It can be learned from FIG. 1 that the optimum charging area M for charging is within an hour (60 minutes) and keeping the temperature of the battery below 40° C. (the optimum charging area is determined by conventional art and the characteristic of a battery).

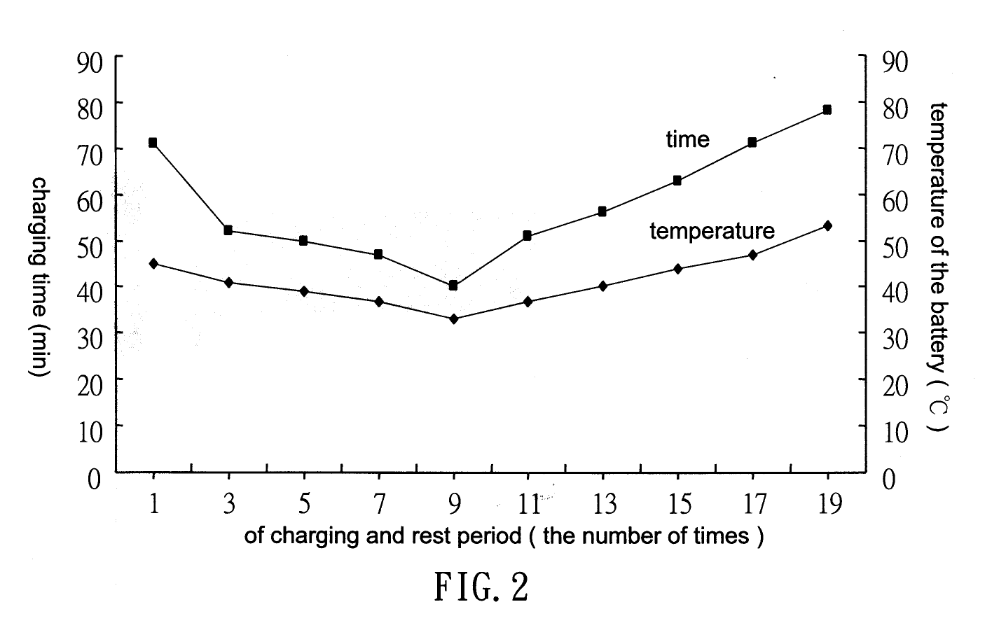

After analyzing the experimental results, the optimum number of times of charging is obtained as shown in FIG. 2. It can be learned from the curves of time and temperature in FIG. 2 that the condition of time and temperature is within the optimum charging area M, if the number of times of charging and rest period is within 5˜13, wherein the charging time will be the shortest (about 30˜45 minutes) and the temperature of the battery is the lowest (about 33° C.) if the number of times of charging and rest period is 9.

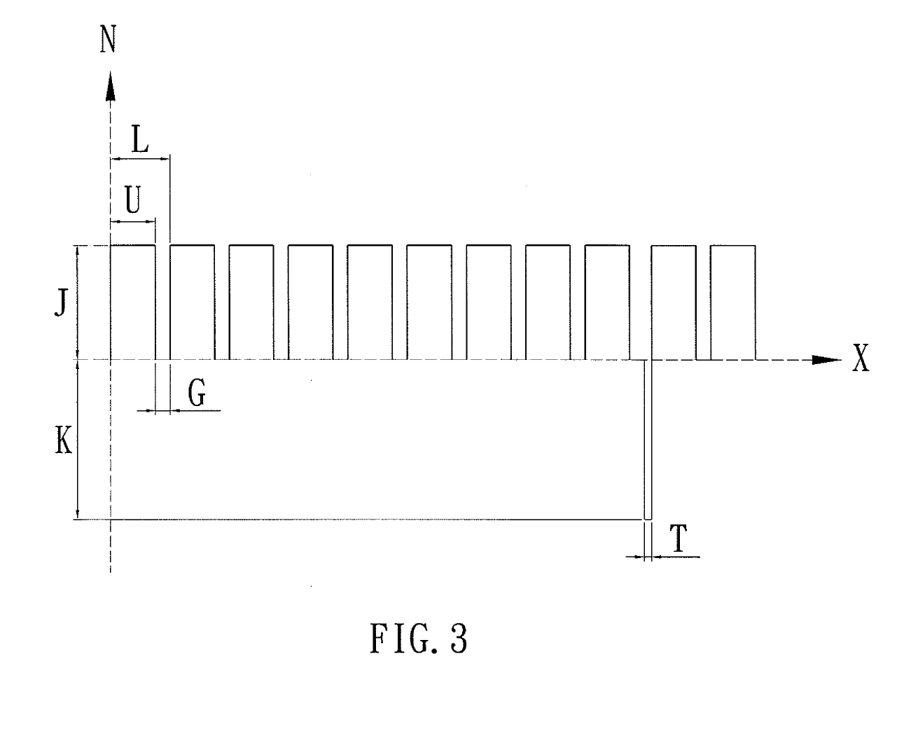

To achieve the objective of the present invention, a charging method of a preferred embodiment of the present invention is designed based on the number of 9 times of charging and rest period. Referring to FIG. 3, the axis X represents time, and axis N represents current. The following is a detailed illustration of the charging steps.

1. providing the battery with a charging and rest section L, and the L includes 9 cycles of charging and rest, and each cycle of charging and rest includes a charging period U and a rest period G, wherein:

the charging period U serves to provide a charging pulse J to the battery. The current of the charging pulse J is smaller than or equals to 3×C (C represents capacitance of the battery, and its unit is ampere per hour), and the time of the charging period is shorter than or equals to 20 seconds;

the rest period J serves to keep the input current of the battery as zero, and the time of the charging period is shorter than or equals to 1 second.

2. providing the battery with a discharging section T, and the discharging section T serves to provide a discharging pulse K to the battery. The current of the discharging pulse K is smaller than or equals to 6×C (C represents capacitance, and its unit is ampere per hour), and the time of the discharging period is shorter than or equals to 5 milliseconds.

3. repeating the steps 1 and 2 alternately until the lead-acid battery reaches to a rated voltage.

The following is an illustration of the advantages and the operation of the present invention.

1. Charging efficiency will be increased. Since the number of times of discharge of the conventional charging method is too great, which will reduce the charging efficiency, while the number of times of discharge associated with the charging method of the present invention is not great, so that the charging efficiency will be increased.

2. The charging method can achieve the objective of charging quickly (within an hour). The low charging efficiency of the conventional method will increase the charging time. The charging method of the present invention can finish charging within an hour, therefore saving time.

3. The charging method will not cause high temperature of the battery (the upper limit of the characteristic of the battery is 40° C.). A conventional charging method will cause the temperature of the battery to exceed 40° C. due to the long charging time. The charging method of the present invention is provided with fixed periods for discharging, so that it will not cause high temperature of the battery and will not destroy the battery.

4. The charging method will increase the service life of the battery. During the course of charging, the inner part of the battery will produce air bubble that will adhere to the surface of electrode panels and will accelerate the erosion of the battery, therefore reducing the service life of the battery. A conventional method utilizes a discharging pulse to eliminate the air bubble. This can effectively eliminate air bubble, but great number of times of discharge will cause a low charging efficiency and cause long charging time and the temperature of the battery to exceed 40° C., therefore reducing the service life of the battery. The charging method of the present invention provides a discharging pulse after a fixed number of times of charging, which can reduce the number of times of discharge and eliminate air bubble on the electrode panels, and will not cause the temperature of the battery to exceed 40° C., therefore increasing the service life of the battery.

To summarize, the charging method of the present invention provides a better charging time and controls the temperature produced during the course of charging in an ideal scope, which not only increases the service life of the battery, but also satisfies the requirement of users.

While we have shown and described various embodiments in accordance with the present invention, it is clear to those skilled in the art that further embodiments may be made without departing from the scope of the present invention.

What is claimed is:

1. A charging method for a lead-acid battery, comprising the following steps:
(A). providing the lead-acid battery with a charging and rest section, and the charging and rest section includes two cycles of charging and rest, and each cycle of charging and rest includes a charging period and a rest period, the charging period serves to provide a charging pulse to the lead-acid battery, and the rest period serves to keep input current of the lead-acid battery at zero;
(B). providing the lead-acid battery with a discharging section, and the discharging section serves to provide a discharging pulse to the lead-acid battery;
(C). repeating the steps (A) and (B) alternately until the lead-acid battery reaches to a rated voltage.

2. The charging method for a lead-acid battery as claimed in claim 1, wherein the time of the charging period is shorter than or equals to 20 seconds.

3. The charging method for a lead-acid battery as claimed in claim 1, wherein the time of the rest period is shorter than or equals to 1 second.

4. The charging method for a lead-acid battery as claimed in claim 1, wherein the time of the discharging period is shorter than or equals to 5 milliseconds.

5. The charging method for a lead-acid battery as claimed in claim 1, wherein the current of the charging pulse is smaller than or equals to 3×C.

6. The charging method for a lead-acid battery as claimed in claim 1, wherein the current of the discharging pulse is smaller than or equals to 6×C.

7. The charging method for a lead-acid battery as claimed in claim 1, wherein the number of times of charging and rest period is 5˜13.

8. The charging method for a lead-acid battery as claimed in claim 1, wherein the number of times of discharging period is 1.
